(19) United States
(12) Patent Application Publication
(10) Pub. No.: US 2006/0293808 A1
(43) Pub. Date: Dec. 28, 2006

(54) Device for self-determination position of a robot

(75) Inventor: Dongqi Qian, Suzhou, Jiangsu (CN)

Correspondence Address: VENABLE LLP, P.O. BOX 34385, WASHINGTON, DC, 20043-9998, US

(73) Assignee: TEK ELECTRICAL (SUZHOU)CO., LTD., Suzhou Jiangsu (CN)

(21) Appl. No.: 10/567,559

(22) PCT Filed: Aug. 11, 2004
(86) PCT No.: PCT/CN04/00931

§ 371 Date: Feb. 8, 2006

(30) Foreign Application Priority Data
Aug. 11, 2003 (CN) 03277609.8

(51) Int. Cl. G01C 22/00

(52) U.S. Cl. 701/23; 701/26

(57) ABSTRACT

The present invention relates to a device of self-determination position of a robot, and said device includes: a robot body; at least two driving wheels locating in two opposed sides of the robot body; a decelerator, connecting with a wheel shaft of said driving wheels through a power inputting portion; a motor, connecting with said power inputting portion of the decelerator through an outputting shaft; at least two driven wheels providing on the robot body, on which there are a plurality of grids around circumference direction taking the wheel shaft as the center; and at least two pairs of sensors, locating in one of outsides of each driven wheels, respectively, wherein said each pair of sensors include an emitting part and a receiving part facing toward said emitting part, moreover, through said grids, said receiving part can receive signals sent from the emitting part. According to the present invention, when said driving wheels lose steps or slip, the driven wheels do not move in respect to the ground, so that said sensors would not output signals about rotation of the wheels. It therefore can really represent the movement relation between said robot body and the ground.

### FIELD OF INVENTION

The present invention relates to a position-determining device, especially a device for self-determination position of a robot.

### BACKGROUND OF INVENTION

In the existing art, a robot (for example an autonomous vacuum cleaner) is able to autonomously avoid obstacles when moving in a defined area, yet it is a difficult problem to solve for the robot to judge its own coordinate position and keep moving along a defined path. Most robots adopt the autonomous navigation and calculation method so as to move according to a virtual house map. The navigation and calculation method includes: measuring the rotation angle of driving wheels of the robot, utilizing a traditional axle-direction encoder to output the rotation angle so as to reflect the displacement of the robot relative to the ground, building an electric map, navigating and moving according to the electric map. However, this technology does not preclude the situations of wheels losing steps or slipping. Once the step-losing or slippage occurs, the encoder on, a driving wheel will still register a wheel rotation even though the wheel is not running the robot, which incorrectly indicates that the robot is still moving relative to the ground. If the accumulating error resulted from losing step or slipping of the driving wheels exceeds an allowable value, the robot will not operate reliably.

Therefore, it is necessary to develop a self-determination position device that is able to directly convert the displacement of a robot relative to the ground to an effective signal for building the electric map or for the robot to navigate.

### SUMMERY OF THE INVENTION

In order to solve the foregoing problems, it is one object of the present invention to provide a self-determination position device of a robot, which regards the ground as the frame of reference and directly converts the displacement of a robot relative to the ground to an effective signal for building an electric map or for the robot to navigate.

In one aspect of the present invention, it is provided with a self-determination position device of a robot, comprising: a robot body; at least two driving wheels locating in two opposed sides of the robot body; at least two power portions providing power for the driving wheels, each of which comprises a decelerator connecting with a wheel shaft of the driving wheels through a power inputting portion and a motor connecting with the power inputting portion of the decelerator through an outputting shaft; at least two driven wheels providing on the robot body, on which there are a plurality of grids along circumference direction taking the driven wheel axle as the center; and at least two pairs of sensors locating in two outsides of each driven wheel, each pair of sensors including an emitting part and a receiving part which faces toward the emitting part and moreover, can receive signals sent from the emitting part through the grids, where the driving wheels are driven to rotate by the motor and the driven wheels are rotated by the movement of the robot body, and when the driven wheels are rotated in a positive or negative direction, the pairs of sensors are able to measure the angles of rotation in positive or negative direction and convert them into positive or negative counting signals for calculating the position of the robot body.

In one embodiment of the present invention, two driven wheels are rotatably arranged on the wheel shaft of the two opposed driving wheels with the driven wheels coaxial with the driving wheels and with a diameter of the driven wheels the same as the diameter of the driving wheels.

In another embodiment of the present invention, both of the two driven wheels are located in front of the driving wheels or located in back of the driving wheels. The self-determination position device of a robot further comprises an extending arm provided on the robot body, the extending arm having two ends extending along two outsides of each driven wheels. And there are two pairs of sensors, the emitting part and the receiving part of each pair of sensors providing on the two ends of each extending arm, respectively.

In another embodiment of the present invention, the driven wheels include a first driven wheel and a second driven wheel, an axle-line of first driven wheel in parallel to the horizontal plane and an axle-line of second driven wheel perpendicular to the horizontal plane. The self-determination position device of a robot further comprises an extending arm provided on the robot body, two ends of which extend along two outsides of the first driven wheel and are provided with two pairs of sensors respectively, and a driven wheel base of the second driven wheel is provided with two pairs of sensors.

In the present invention, the angle between two connecting lines lying between the axle of the driven wheel and two sensors α=360n/Nz+90/Nz, wherein n is an integer, and Nz is the number of grids.

Compared with the existing art, the advantage of the present invention is that when the driving wheels lose steps or skid, the driven wheels will not move relative to the ground, and the sensors on the driving wheels will not output a signal indicating that the wheels are moving relative to the ground, so that it can really represent the movement relation between the robot body and the ground and it solves the problem of incorrect navigation in the existing art of measuring the rotation angle of driving wheels so as to judge whether the robot body moves or not.

### BRIEF DESCRIPTION OF THE DRAWINGS

The present invention will be further described blow in conjunction with the brief description of the drawings:

FIG. 1 is a front plan view of the present invention of Embodiment 1;

FIG. 2 is a front plan view of the left part of the present invention of Embodiment 1;

FIG. 3 is a cross-sectional view of the left part of the present invention of Embodiment 1;

FIG. 4 is a schematic view of driven wheels of FIG. 3 in direction A;

FIG. 5 is a schematic view of extending arm and driven wheels of FIG. 3 in direction B;

FIG. 6 is a schematic view of two pairs of sensors of FIG. 5;

FIG. 7 is a front plan view of the present invention of Embodiment 2;

FIG. 8 is a bottom plan view of the present invention of Embodiment 3;

FIG. 9 is a back plan view of the present invention of Embodiment 4;

FIG. 10 is an enlarged cross-sectional view of the rotating wheel in FIG. 9;

FIG. 11 is a front plan view of the present invention of Embodiment 4;

FIG. 12 is an enlarged cross-sectional view of the driven wheels in FIG. 9;

FIG. 13 is a bottom plan view of the present invention of Embodiment 4;

FIG. 14 is an enlarged front plan view of the rotating wheel of Embodiment 4;

FIG. 15 is an enlarged left plan view of the driven wheels of Embodiment 4;

### DESCRIPTION OF THE PREFERRED EMBODIMENTS

Hereinbelow, the present invention will be described specifically with reference to the drawings. In the descriptions below, the same marks in different drawings represent the same components.

Embodiment 1

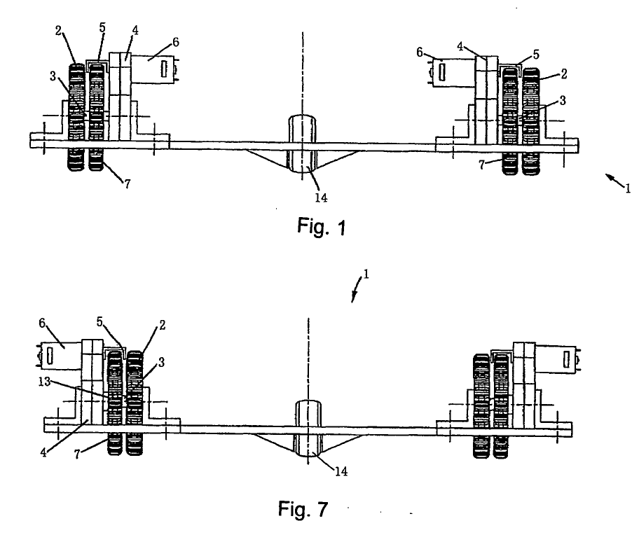

FIG. 1 is a front plan view of the present invention of Embodiment 1. The two opposed sides of the rolling wheel 14 have symmetrical configurations, thus only left side is illustrated for detailed description.

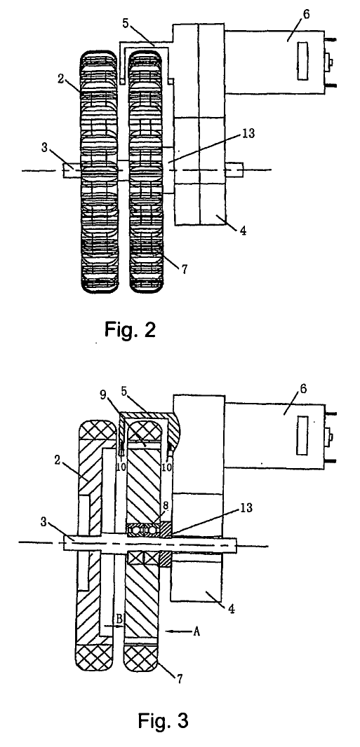

Referring to FIG. 1, FIG. 2 and FIG. 3, the left side of the device includes driving wheel 2, driven wheel 7, decelerator 4 and motor 6 in the sequence from outside to inside.

The driving wheel 2 is fixed to the wheel shaft 3. The wheel shaft 3 is connected to the power output portion of the decelerator 4. The power input portion of the decelerator 4 is connected to the outputting shaft of the motor 6. Thus the motor 6 drives the wheel shaft 3 to rotate and further causes the driving wheel 2 to rotate as well.

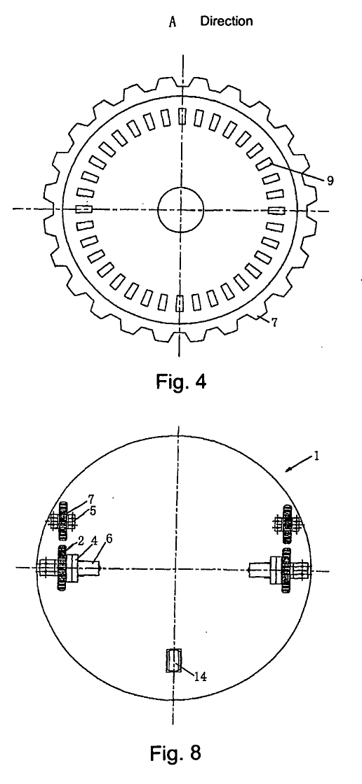

The driven wheel 7 is rotatably arranged on the wheel shaft 3 of the driving wheel 2 by a bearing 8 and is also fixed between the projecting part and the shaft sheath 13. The driven wheel 7 is arranged coaxially with the driving wheel 2 and the diameter of the driven wheel 7 is the same as that of the driving wheel 2. The driven wheel 7 does not rotate as the bearing 8 rotates, but it rotates as the robot body 1 moves. In addition, referring to FIG. 4, the driven wheel 7 has a plurality of grids 9 radially deposed thereon with respect to the wheel shaft 3.

The decelerator 4 is arranged adjacent to the shaft sheath 13 and is connected to the wheel shaft 3 by spline.

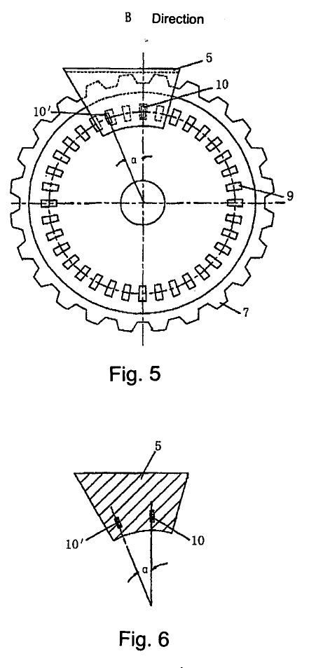

The motor 6 is provided with an extending arm 5 that spans over the driven wheel 7 with its two ends extending along the outsides of the driven wheel 7. Referring to FIG. 3, FIG. 5 and FIG. 6, the two ends of the extending arm 5 are provided with a first pair of sensors 10 and a second pair of sensors 10′, respectively. The pair of sensors, having an emitting part and a receiving part that faces each other, can be an infrared emitter and an infrared receiver arranged on the corresponding ends of the extending arm 5, wherein the receiving part is able to receive the signals sent from the emitting part through the grids 9.

Embodiment 2

FIG. 7 is a front plan view of the present invention of Embodiment 2. The configuration of the device in Embodiment 2 is the same with that in Embodiment 1 except for that the arrangement sequence of components on two sides of the rolling wheel 14 in Embodiment 2 is reverse to the arrangement sequence of components in Embodiment 1. Taking the left side of the device as an example, the left side of the device includes a motor 6, a decelerator 4, driven wheels 7 and driving wheels 2 in the sequence from outside to inside.

Embodiment 3

FIG. 8 is a bottom plan view of the present invention of Embodiment 3. The two opposed sides of the rolling wheel 14 have symmetrical configurations, thus only left side is illustrated for detailed description.

Referring FIG. 8, the front portion of the left side of the device is provided with a driven wheel means and the rear portion is provided with a driving wheel means. The rear portion includes a driving wheel 2, a decelerator 4 and a motor 6 in the sequence from outside to inside. The driving wheel 2 is fixed to the wheel shaft 3, which drives the driving wheel 2 to rotate as the wheel shaft 3 rotates. The decelerator 4 is arranged immediately adjacent to the driving wheel 2 and is connected to the wheel shaft 3. The motor 6 is connected to the power input portion of the decelerator 4 through the outputting shaft.

The driven wheel 7, having a same diameter with that of driving wheel 2, is arranged on the robot body 1 and moves as the robot body 1 moves, its grids are similar with those in Embodiment 1. The diameter of the driven wheel 7 is the same as that of the driving wheel 2.

The extending arm 5 is also arranged on the robot body 1, on which the sensors are similar with those in Embodiment 1.

In the above-mentioned three embodiments, the device of self-determination position for a robot is generally operated in the following way: the motor 6 outputs its power to the decelerator 4, and the decelerator 4 further transfers the power to the wheel shaft 3, and the wheel shaft 3 drives the driving wheels 2 to rotate, which causes friction between the driving wheel and the ground, so that the robot body 1 moves relative to the ground. Meanwhile the driven wheels 7 as well as the grids thereon move as the robot body 1 moves. The angle between two connecting lines lying between the axle of the driven wheel and two sensors α=360n/Nz+90/Nz, wherein n is an integer, and Nz is the number of grids. When the driven wheels are rotated in a positive or negative direction, the pairs of sensors are able to measure the angles of rotation in positive or negative direction and convert them into positive or negative counting signals for calculating the position of the robot body.

Embodiment 4

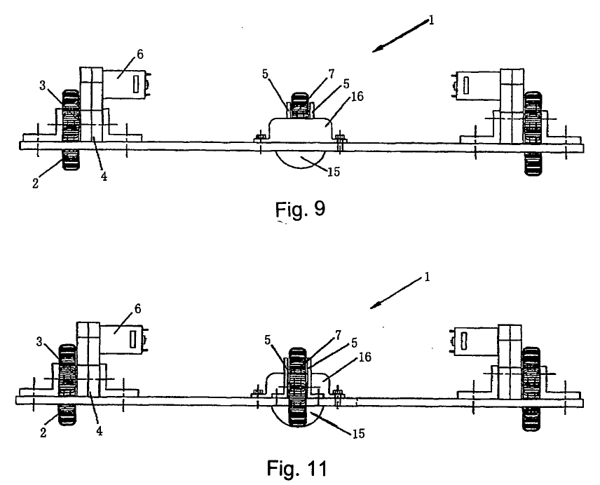

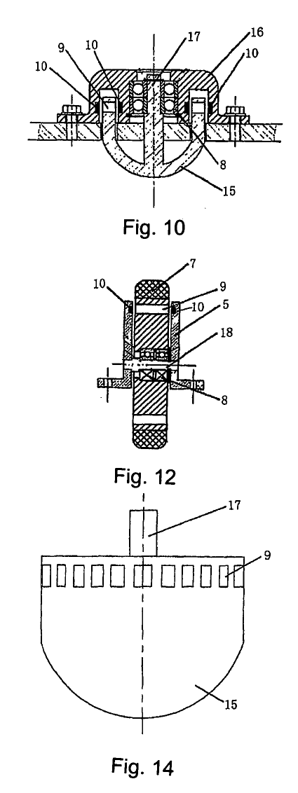

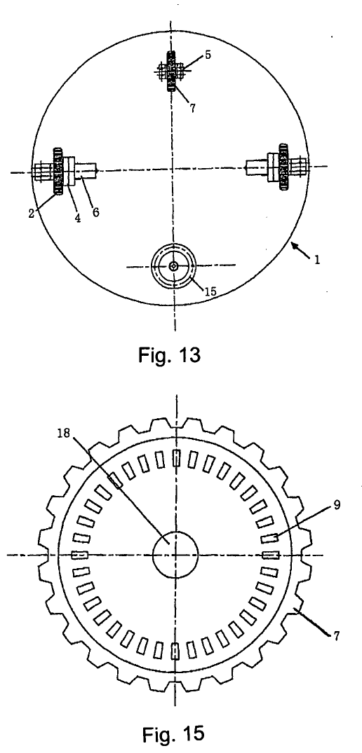

Referring to FIG. 11, FIG. 12, FIG. 13 and FIG. 15, the driving wheels in Embodiment 4 are basically the same as the driving wheels in Embodiment 3. The device for self-determination position of a robot comprises two driven wheels 7 located along a line perpendicular to the axle-line of the driving wheels 2, where one of the driven wheels has a same configuration as that of the driven wheel in Embodiment 3 with its axle-line parallel to the horizontal plane, and the other driven wheel 7(also named rotating wheel 15 in the drawings), has a axle-line perpendicular to the horizontal plane. The rotating wheel 15, showed in FIG. 9, FIG. 10, FIG. 13, and FIG. 14, has a configuration combining a hollow column and a hemisphere and is rotatable around its axle 17. The column wall of the rotating wheel 15 is defined with a plurality of grids 9 that are evenly arranged thereon along circumference direction. The rotating wheel base 16 is provided with a first pair of sensors 10 and a second pair of sensors (not showed in the drawings) that are fixed to two opposed sides of the axle 17 and are similar to the sensors in Embodiment 1.

In this embodiment, the device of self-determination position for a robot is operated in the following way: the motor 6 outputs its power to the decelerator 4, and the decelerator 4 further transfers the power to the wheel shaft 3, and the wheel shaft 3 drives the driving wheels 2 to rotate, which causes friction between the driving wheels and the ground, so that the robot body 1 moves relative to the ground. Meanwhile the driven wheel 7 and the rotating wheel 15 as well as the grids thereon rotate as the robot body 1 moves. When the driven wheels are rotated in positive or negative direction, the pairs of sensors are able to measure the angles of rotation in positive or negative direction and convert them into positive or negative counting signals for calculating the position of the robot body.

While the invention has been specifically described in connection with certain specific embodiments thereof, it is to be understood that this is by way of illustration and not restrictive. Reasonable variation and modification are possible within the scope of the forgoing description and drawings without departing form the spirit of the invention, which is defined in the appended claims.

1. A self-determination position device of a robot, comprising
a robot body;
at least two driving wheels locating in two opposed sides of said robot body;
at least two power portions providing power for said driving wheels, each of which comprises:
a decelerator connecting with a wheel shaft of said driving wheels through a power inputting portion;
a motor connecting with the power inputting portion of said decelerator through an outputting shaft;
at least two driven wheels providing on said robot body, on which there are a plurality of grids along circumference direction taking the driven wheel axle as the center; and
at least two pairs of sensors locating in two outsides of each driven wheel, said each pair of sensors including an emitting part and a receiving part which faces toward the emitting part and moreover, can receive signals sent from the emitting part through the grids;
wherein said driving wheels are driven to rotate by the motor and said driven wheels are rotated by the movement of the robot body, and when the driven wheels are rotated in a positive or negative direction, said pairs of sensors are able to measure the angles of rotation in positive or negative direction and convert them into positive or negative counting signals for calculating the position of the robot body.

2. The self-determination position device of a robot as claimed in claim 1, wherein two said driven wheels are rotatably arranged on the wheel shaft of the two opposed driving wheels with the driven wheels coaxial with the driving wheels, and a diameter of the driven wheels is the same as the diameter of said driving wheels.

3. The self-determination position device of a robot as claimed in claim 2 further comprising an extending arm provided on the motors, and said extending arm has two ends extending along two outsides of each driven wheels.

4. The self-determination position device of a robot as claimed in claim 3, wherein there are two pairs of sensors, the emitting part and the receiving part of each pair of sensors providing on the two ends of the extending arm, respectively.

5. The self-determination position device of a robot as claimed in claim 1, wherein there are two driven wheels, both of which located in front of the driving wheels or located in back of the driving wheels.

6. The self-determination position device of a robot as claimed in claim 5 further comprising an extending arm provided on the robot body, and said extending arm has two ends extending along two outsides of each driven wheels.

7. The self-determination position device of a robot as claimed in claim 6, wherein there are two pairs of sensors, the emitting part and the receiving part of said each pair of sensors providing on the two ends of the extending arm, respectively.

8. The self-determination position device of a robot as claimed in claim 1, wherein the driven wheels include first driven wheel and second driven wheel, an axle-line of first driven wheel in parallel to the horizontal plane and an axle-line of second driven wheel perpendicular to the horizontal plane.

9. The self-determination position device of a robot as claimed in claim 8 further comprising an extending arm provided on the robot body, two ends of which extend along two outsides of the first driven wheel and are provided with two pairs of sensors respectively, and a driven wheel base of the second driven wheel is provided with two pairs of sensors.

10. The self-determination position device of a robot as claimed in claim 1, wherein an angle between two connecting lines lying between the axle of the driven wheel and two sensors α=360n/Nz+90/Nz, wherein n is an integer, and Nz is the number of grids.
